(19) United States
(12) Patent Application Publication
(10) Pub. No.: US 2024/0105382 A1
(43) Pub. Date: Mar. 28, 2024

(54) CENTER-TAPPED ISOLATION TRANSFORMER

(71) Applicant: TEXAS INSTRUMENTS INCORPORATED, Dallas, TX (US)

(72) Inventors: Kashyap BAROT, Bengaluru (IN); Sreeram S, Bengaluru (IN); Kumar Anurag SHRIVASTAVA, Bengaluru (IN); Viresh CHINCHANSURE, Bengaluru (IN)

(21) Appl. No.: 17/954,735

(22) Filed: Sep. 28, 2022

(51) Int. Cl. H01F 27/30; H01F 27/32

(52) U.S. Cl. CPC H01F 27/303; H01F 27/306; H01F 27/324

(57) ABSTRACT

A transformer includes a substrate and a first metal layer having a first inductor having a first center tap. A second metal layer includes a second inductor having a second center tap, and the second metal layer includes a bond pad. A third metal layer includes a first conductor electrically connecting the bond pad to the first center tap, and the third metal layer includes a second conductor electrically connecting the bond pad and the first center tap. The third metal layer is situated between the substrate and the first metal layer, and the first metal layer is situated between the third metal layer and the second metal layer.

### BACKGROUND

Many circuits include transistors. An example of a transistor is a field effect transistor (FET) such as an n-channel FET (NFET) or a p-channel FET (PFET). An NFET is turned ON by injecting current into the gate of the transistor to cause the voltage of the gate relative to the source to exceed the threshold voltage (Vt) of the transistor. In some applications, the source of the transistor is not connected to the ground of the circuit. For example, in the case of a high side FET coupled to a low side FET between a supply voltage and ground (a configuration that is typical of, for example, motor controllers, switching voltage regulators, etc.), the source of the high side FET is (or is connected to) the switch node for the circuit and is a voltage (relative to ground) that changes during each switching cycle.

In such applications, a controller drives (possibly, through a driver circuit) a digital signal (e.g., a voltage) to cause the high side FET to turn ON. The controller is coupled to circuit ground and its digital signal is a voltage with respect to circuit ground. To turn ON the high side FET, a gate driver coupled to the gate of the FET must produce a sufficient voltage on the gate of the high side FET with respect to the switch node voltage, which is a different voltage than circuit ground.

In some such applications, a signal isolator is included between the controller and the gate driver for the high side FET. The signal isolator is coupled to circuit ground and to the ground reference for the high side FET (e.g., the switch node). The signal isolator isolates the ground reference of the controller from the ground reference of the gate driver for the high side FET.

### SUMMARY

In one example, a transformer includes a substrate and a first metal layer having a first inductor having a first center tap. A second metal layer includes a second inductor having a second center tap, and the second metal layer includes a bond pad. A third metal layer includes a first conductor electrically connecting the bond pad to the first center tap, and the third metal layer includes a second conductor electrically connecting the bond pad and the first center tap. The third metal layer is situated between the substrate and the first metal layer, and the first metal layer is situated between the third metal layer and the second metal layer.

### BRIEF DESCRIPTION OF THE DRAWINGS

For a detailed description of various examples, reference will now be made to the accompanying drawings in which:

FIG. 1 is a three-dimensional view of a device containing a transformer in accordance with an example.

FIG. 2 is a close-up view of the transformer of FIG. 1, in accordance with an example.

FIG. 3 is the transformer of FIGS. 1 and 2 illustrating the inductors forming the transformer, in accordance with an example.

FIG. 4 is a view of one of the inductors of the transformer illustrating the bifurcated connection between the inductor's center tap and a bond pad, in accordance with an example.

FIG. 5 is a bottom view of the inductor of FIG. 4, in accordance with an example.

FIG. 6 is an alternative configuration of a transformer, in accordance with an example.

FIG. 7 is a depiction of the inductor of FIG. 6 in an example.

FIG. 8 is an electrical schematic illustrating that an inductor of the transformer of FIG. 6 is a center-tap inductor in an example.

FIG. 9 is a schematic diagram of a system which includes the transformer described herein, in accordance with an example.

The same reference numbers or other reference designators are used in the drawings to designate the same or similar (either by function and/or structure) features.

### DETAILED DESCRIPTION

A transformer can be figured to include a primary winding and a secondary winding such that the certain signals at the primary winding may be isolated from the secondary winding (and vice versa). Therefore, such transformers can provide the signal isolation described above, although other uses of the transformer described herein are possible as well. The example transformer described herein is a center-tapped transformer (each of the primary and secondary coils has a center tap) that is constructed in such a way to reduce the conversion of common mode voltage (e.g., a voltage whose value is relative to a common potential, such as ground) to a differential voltage (e.g., a voltage whose value is the difference between the voltages at two differential terminals). A common mode voltage may be, for example, a common mode noise that is present on the ground terminals of the transformer's coils. The described transformer also has a relatively high common mode rejection ratio (CMRR).

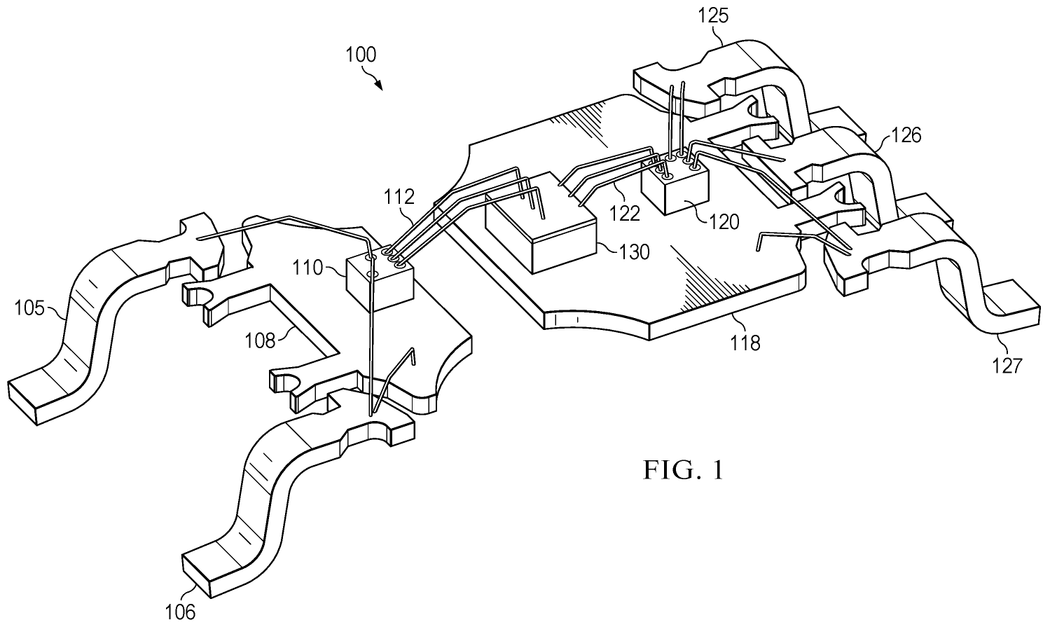

FIG. 1 is a three-dimensional view of a device 100. Device 100 includes a transmitter 110, a receiver 120, and a transformer 130. The transformer 130 is coupled between the transmitter 110 and receiver 120. Bond wires 112 couple the transmitter 110 to the transformer 130. Bond wires 122 couple the transformer 130 to the receiver 120. Each of the transmitter 110, receiver 120, and transformer 130 may be fabricated as individual dies. Transmitter 110 is supported by a support platform 108 (e.g., metal or other suitable type of support structure). Transformer 130 and receiver 120 may be supported by another support platform 118. Leads 105 and 106 provide connectivity to the transmitter 110, and leads 125, 126, and 127 provide connectivity to the receiver 120. The structure shown in FIG. 1 may be encapsulated with a mold compound or suitable material. In this example, transmitter 110 is implemented in/over a single semiconductor die (such as a silicon substrate) that includes one or more metalization/conductor layers situated over the semiconductor stubstrate and separated from each other by one or more insulating layers. Similary, transformer 130 is implemented in/over another semiconductor die having one or more metalization/conductor layers situated over the semiconductor substrate and separated from each other by one or more insulating layers. Receiver 120 may be implemented on a separate semiconductor die than transformer 130 or both receiver 120 and transformer 130 may be fabricated in/over the same semiconductor die. In other examples, the leads (e.g., portions of a leadframe) may be replaced by balls (such as part of a ball-grid array), pins (such as part of a pin-grid array) and/or another other structure that is used to interconnect semiconductor devices. As such, the term “lead” is used throughout and is meant to generally mean any type of interconnect (such as leads, balls, pins, etc.) used with semiconductor devices. In other examples, transmitter 110, receiver 120 and transformer 130 are each implemented using wafer-scale packaging where balls (or other interconnections) are used to directly connect these devices to a printed circuit board (PCB). As such, bond wires 112 and 122 may be replaced with conductors/traces on the printed circuit board.

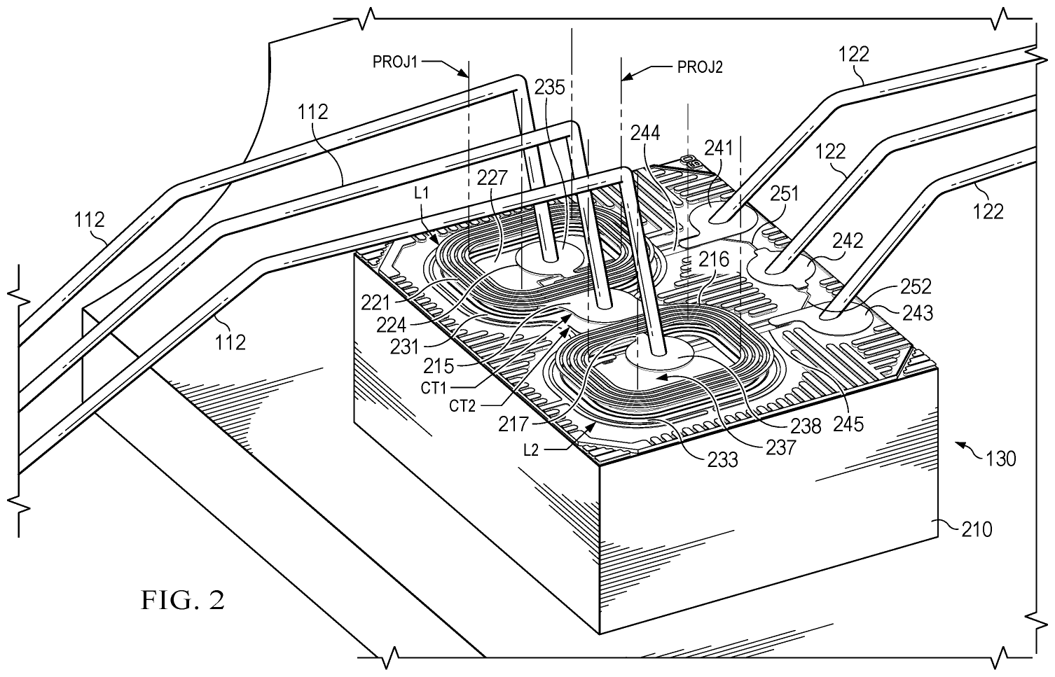

FIG. 2 is a close-up view of the transformer 130. The transformer 130 includes center-tapped inductors L1 and L2 formed on/over a substrate 210 (such as a single-crystal silicon subrate and/or an epitaxial silicon layer formed over a single-crystal silicon substrate—other materials, such as polyamide, insulating material, gallium nitride, silicon carbride, gallium arsenic, etc. may be used inplace of or in conjuction with silicon). The inductors L1 and L2 also may be referred to as “windings” or “coils” (e.g., a primary winding or coil L1 and a secondary winding or coil L2 of the transformer). Inductors L1 and L2 are formed in separate layers (e.g., metal layers, or other suitable material for forming an inductor) separated by one or more layers of an insulating material (e.g., silicon dioxide, silicon nitride, silicon oxynitride, etc). Inductor L1 includes conductive lines (also called traces—comprising, for example, copper, aluminum, gold, tungsten, titanium, tantalum, a conductive nitride thereof and/or a combination or layering thereof) that form concentric rings 221 and 223. Concentric ring 221 includes N turns of the conductive lines between an interior connection point 214 and an exterior connection point 215 of the ring. In the example of FIG. 2, N is 5 (the concentric ring 221 includes 5 turns). The opposing concentric ring 223 of inductor L1 also includes N turns (e.g., 5 turns) between an exterior connection point 216 and an interior connection point 217. A center tap CT1 is coupled to and between the concentric rings 221 and 223 and provides electrical connectivity from the conductive lines of the concentric ring 221 to conductive lines of concentric ring 223. In one example, the center tap CT1 is a metal structure formed in the same metal layer as the concentric rings 221 and 223.

A bond pad is provided in the interior space defined by each concentric ring 221, 223. Bond pad 235 is provided in interior space 227 defined by concentric ring 221, and bond pad 238 is provided in interior space 237 defined by concentric ring 223. The interior space defined by each of the concentric rings may be filled with a suitable material such as dielectric material (e.g., silicon dioxide). Reference identifier PROJ1 identifies a projection of the interior space 227 along an axis normal to the plane of the concentric ring 221. Similarly, PROJ2 identifies a geometric projection of the interior space 237 along an axis normal to the plane of the concentric ring 223. A separate bond wire 112 is coupled to each of the bond pads 235 and 238 as well as the center tap CT1, as shown. Alternatively, a ball may be formed on each bond pad for wafer-scale packaging.

Starting at bond pad 235 within the concentric ring 221, the conductive lines of ring 221 wrap around the interior space 227 in a counterclockwise direction. The exterior connection point 215 of ring 221 couples to one end of the center tap CT1. The opposing end of the center tap CT1 is coupled to exterior connection point 216 of concentric ring 223. The conductive lines of concentric ring 223 wrap around the interior space 237 in a clockwise fashion and end at interior connection point 217 which is coupled to a bond pad 238. In this configuration, current that flows in one direction through concentric ring 221 flows in the opposite direction through concentric ring 223. For example, current that flows clockwise through concentric ring 221 flows counterclockwise through concentric ring 223, and current that flows counterclockwise through concentric ring 221 flows clockwise through concentric ring 223.

Inductor L2 similarly includes concentric rings 231 and 233 coupled to opposing ends of a center tap CT2. The metal layer in which inductor L2 is formed is between the substrate 210 and the metal layer in which inductor L1 is formed. An isulating layer (comprised of one or more layers of insulating material, such as silicon dioxide, silicon nitride, silicon oxynitride and/or a mixture thereof) is formed between L2 and L1 and between L2 and substrate 210. The concentric rings 231 and 233 of inductor L2 generally align vertically with the concentric rings 221 and 223 of inductor L1. The interior spaces of the concentric rings 231 and 233 also generally align with the interior spaces 227 and 237 of the concentric rings 221 and 223. The interior space projections PROJ1 and PROJ2 correspond to the projections of the interior spaces of the concentric rings for both inductors L1 and L2.

As shown in this example, inductors L1 and L2 are formed in a stacked arrangement. Bond pads 235 and 238 at opposing terminals of inductor L1, as well as center tap CT1, are readily exposed to receive bond wires 112. However, the corresponding connections to inductor L2 are in a metal layer between the metal layer in which inductor L1 is formed and the substrate 210 and thus may not be available for receiving bond wire connections. Instead, bond pads 241, 242, and 243 are provided to the side of the inductors L1 and L2. For example, if L2 is formed by the metal-2 layer and L1 is formed by the metal-3 layer, the metal-1 layer may be used to form the interconnections with L2 and bond pads 241, 242 and 243. Bond pads 241, 242, and 243 may be formed in the same metal layer as the layer that includes inductor L2 or they may be formed in the layer that includes inductor L1 (e.g., using vias/interconnections between the metal layer that L2 is formed and the metal layer that L1 is formed). Bond pads 241 and 243 are coupled to opposing terminals of inductor L2 by way of conductive lines 244 and 245, respectively. Bond pad 242 is coupled to the center tap CT2 of inductor L2 by way of two (or more) separate conductive lines 251 and 252. As explained below, the bifurcated connection between center tap CT2 and its bond pad 242 results in transformer 130 having a higher CMRR and lower common mode-to-differential voltage conversion, which results in the transformer having a higher degree of radiated noise immunity.

In one embodiment, the shape of the concentric rings is rectangular with curved corners, as shown. In this embodiment, each ring is defined by straight segments with approximately curved corners. In other embodiments, the rings may be circular, oval, or another suitable shape.

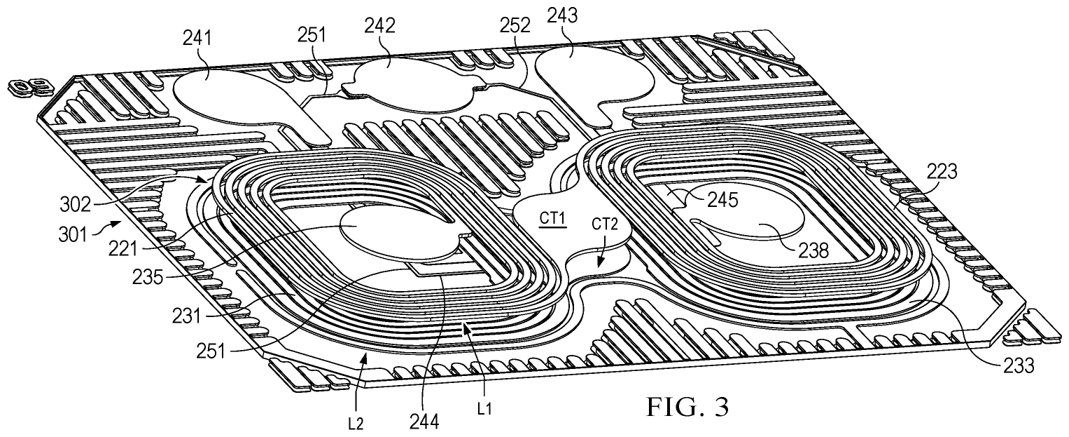

FIG. 3 is a perspective view illustrating metal layers 301 and 302. Inductor L1 is formed in metal layer 302, and inductor L2 is formed in metal layer 301. Metal layer 301 also includes the bond pads 241, 242, and 243. Conductive lines 251 and 252 interconnecting bond pad 242 to center tap CT2 are formed in a metal layer (not numbered in FIG. 3) that is between metal layer 301 and the substrate 210. Conductive lines 251 and 252 are coupled to bond pad 242 and to the center tap CT2 by way of conductive vias/interconnections (e.g., a conductive structure that is formed in the insulating layer between metals layers 301 and 302 and extending between metal layer 301 and 302—the conductive vias/interconnections may be formed using the same metal(s) as metal layers 301 and/or 302). The conductive lines 244 and 245 coupling bond pads 241 and 243 to opposing ends of inductor L2 may be formed in the same metal layer as conductive lines 251 and 252. A dielectric material (e.g., silicon dioxide) is between the metal layers 301 and 302 and between metal layer 301 and the metal layer containing conductive lines 244, 245, 251 and 252.

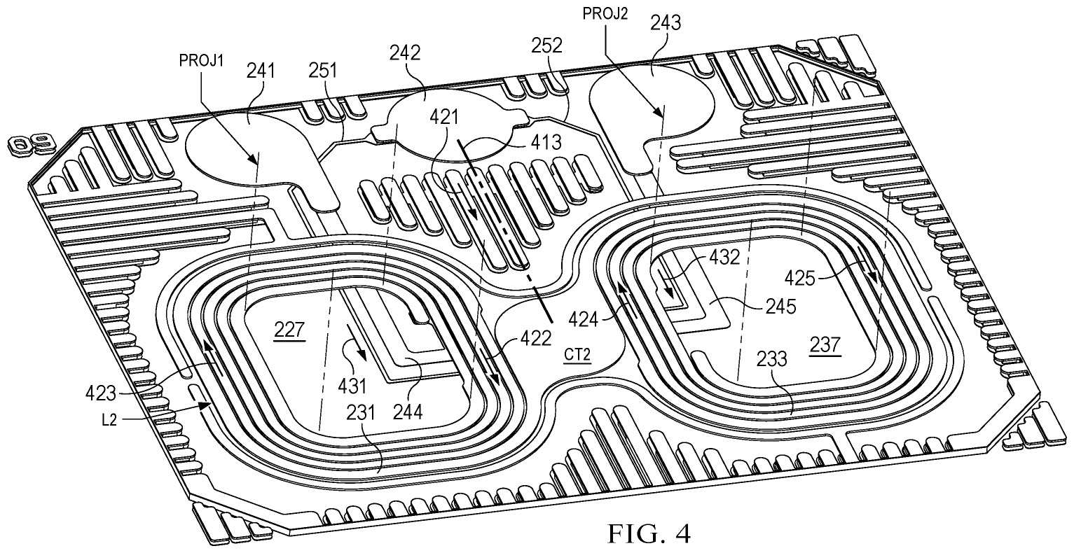

FIG. 4 is a perspective view of inductor L2 (inductor L1 is not shown in this figure). Conductive lines 251 and 252 are in a different metal layer from bond pad 242 and extend laterally from the bond pad and then turn towards their respective concentric rings 231 and 233. The opposing ends of conductive lines 251 and 252 are underneath the center tap CT2 in this view (and thus cannot be seen in this particular figure) and connect to center tap CT2 by way of vias. With respect to center tap CT2, conductive line 244 extends inside conductive line 251, whereas conducive line 252 extends inside conductive line 245. In this example, conductive line 251 pass underneath bond pad 241, but conductive line 252 does not pass underneath bond pad 243. Conductive lines 244 and 245 are in the same metal layer, which may be in the same metal layer as conductive lines 251 and 252.

The projections PROJ1 and PROJ2 of the interiorspaces 227 and 237, respectively, described above are shown in FIG. 4. Each of the bifurcated conductive lines 251 and 252 from bond pad 242 to center tap CT2 pass through the respective projections of the interior spaces of the concentric rings of inductor L2. Conductive line 251 passes through the projection PROJ1 of the interior space 227 of concentric ring 231. Conductive line 252 passes through the projection PROJ2 of the interior space 2337 of concentric ring 233.

If, instead of a bifurcated conductive line connection between bond pad 252 and centertap CT2, a single conductive line 413 may be used to connect the bond pad to the centertap. The conductive line 413 would be outside the projections PROJ1 and PROJ2, and current injected into bond pad 242 would flow from the bond pad 242 in the direction of arrow 421 into the centertap CT2. From the centertap CT2, a portion of the current would flow clockwise in concentric ring 231, and another portion of the current would flow clockwise in concentric ring 233. Current on the righthand side of concentric ring 231 would flow in the direction of arrow 422, and current on the lefthand side of concentric ring 231 would flow in the direction of arrow 423. Current on the lefthand side of concentric ring 233 would flow in the direction of arrow 424, and current on the righthand side of concentric ring 233 would flow in the direction of arrow 425.

The righthand side of concentric ring 231 is closer to the single conductive line 413 than the lefthand side of concentric ring 231. The direction of current flow in condutive line 413 (arrow 421) is the same as the direction of current flow in the closer righthand side of concentric ring 231 (arrow 422). However, due to current flowing in the opposite direction in concentric ring 231, the direction of current flow in condutive line 413 (arrow 421) is opposite that of current flow in the closer lefthand side of concentric ring 233 (arrow 424). As a result of current flow 421 and 422 being in the same direction but current flow 421 and 424 being in opposing directions, the mutual inductance is larger as between conductive line 413 and the righthand side of concentric ring 231 than between conducitve line 413 and the lefthand side of concentric ring 233.

The embodiments described herein bifurcate the connection between bondpad 242 and centertap CT2 to include conductive lines 251 and 252. Because each conductive line 251 and 252 passes through the projection of the interior spaces defined by the inductor's concentric rings 231 and 233, the mutual inductance between each conductive line 251, 252 and the lefthand and righthand sides of its respective concentric ring generally cancels. Current that flows from bond pad 242 in the direction of arrow 431 through conductive line 251 is in the same direction as arrow 422 and in the opposite direction as arrow 423. Similarly, current that flows from bond pad 242 in the direction of arrow 432 through conductive line 252 is in the same direction as arrow 425 and in the opposite direction as arrow 424. This configuration of conductive lines 251 and 252 improves the symmetry of the transformer and has been shown by simulation-based analysis to reduce the conversion of common mode voltage to differential voltage conversion.

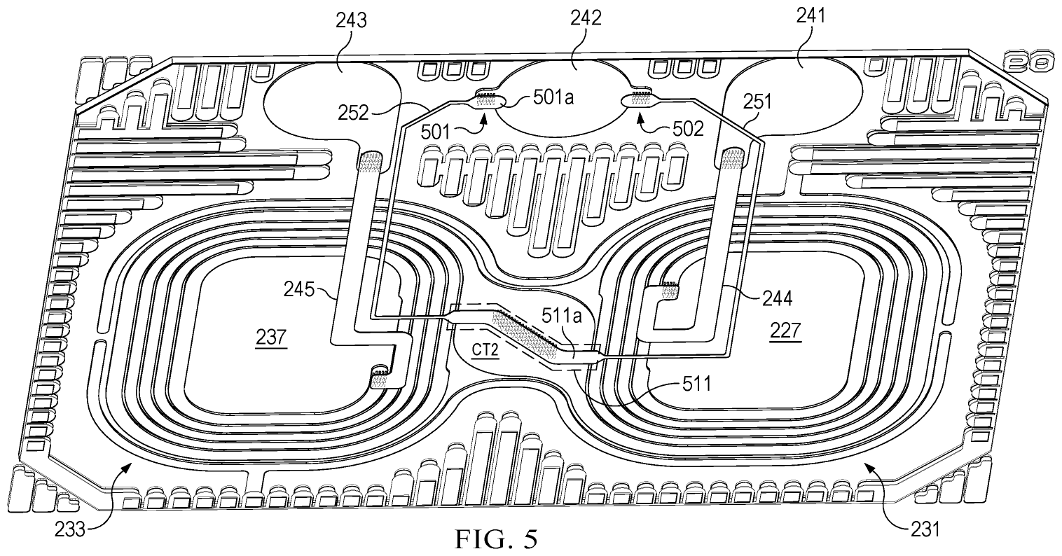

FIG. 5 shows the opposing surface of inductor L2 (relative to the view of FIG. 4) further illustrating conductive lines 244, 245, 251, and 252 underneath concentric rings 231 and 233. As discussed above, if conductive structures 241, 243, 233, 231 and CT2 are formed in conductive layer metal-2 (layer 301), conductive structures 244, 245, 251 and 252 would be formed in underlying conductive layer metal-1 and L1 would be formed in overlying conductive layer metal-3 (layer 302). Conductive line 252 couples to bond pad 242 by way of a connecting structure 501 (such as a via/interconnection, which electrically connects the two structures and may be formed of the same conductive material(s)). Connecting structure 501 includes a conductive pad 501a and one more conducting vias/interconnections. A similar connecting structure 502 connects conductive line 251 to bond pad 242. The opposing ends of conductive lines 251 and 252 are coupled to the bottom side of the center tap CT2 by way of a connecting structure 511, which also includes a conductive pad 511a and one or more vias/interconnections. Conductive lines 244 and 245 connect to their corresponding bond pads 241 and 243 and to the ends of inductor L2 by way of similar connecting structures.

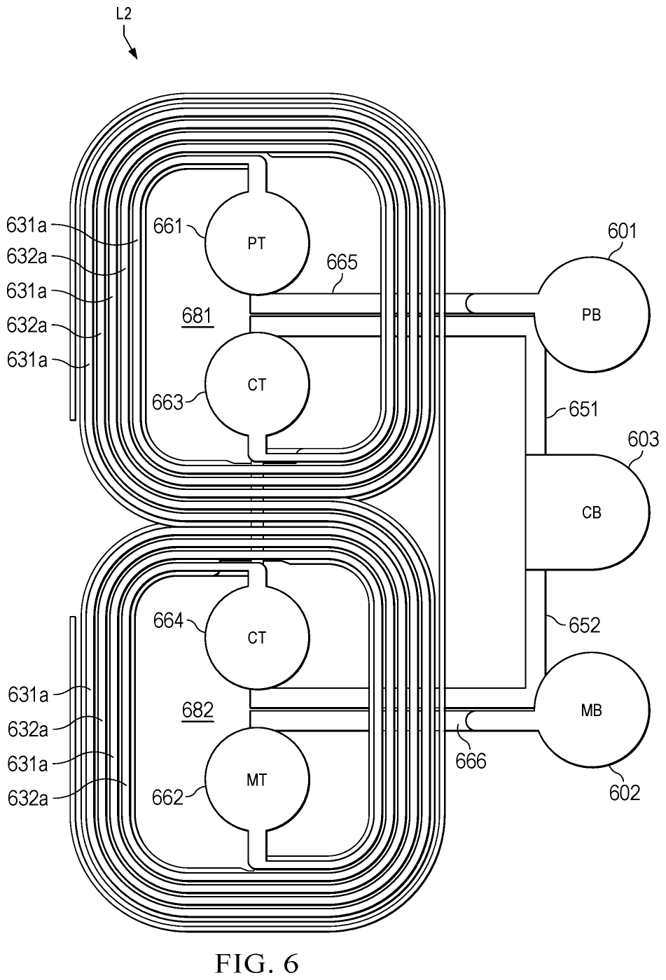

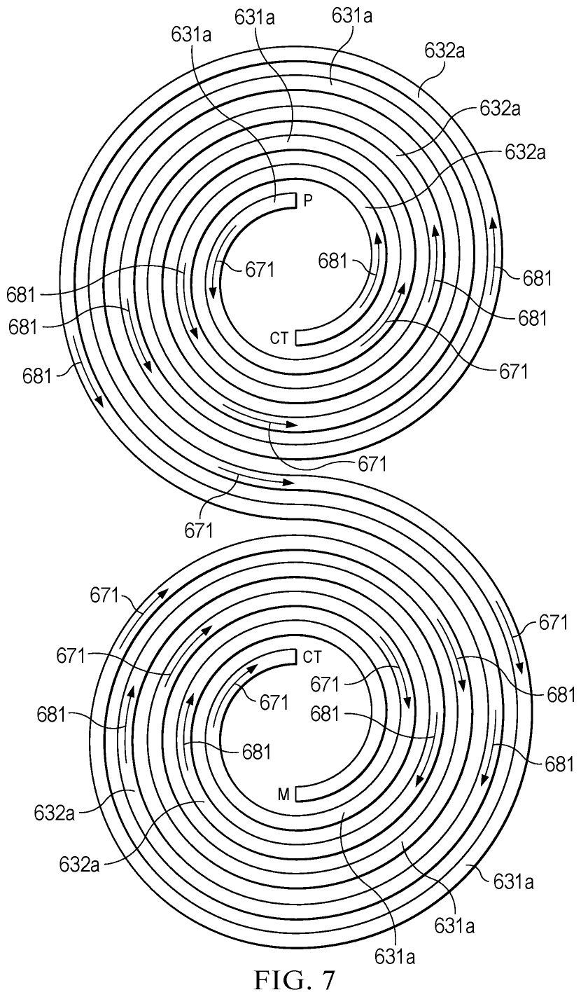

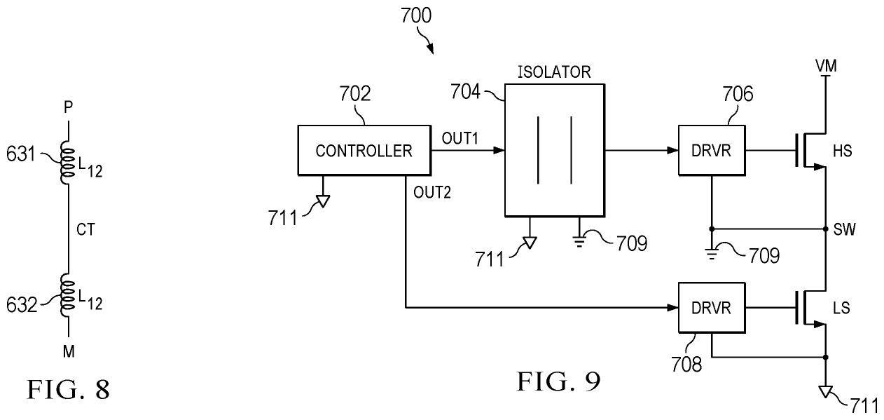

FIGS. 6 and 7 show an alternative embodiment of center-tapped inductor L2. FIG. 6 illustrates the layout of inductor L2. Inductor L1, which would be above inductor L2, is not shown for ease of understanding. FIG. 7 is a conceptual depiction of the inductor. FIG. 8 is an electrical diagram illustrating that the inductor L2 includes inductors 631 and 632 coupled together by way of a center CT. Bond pads 601, 602, and 603 may receive bondwires for connection to the inductor. Bond pad 603 is for the center-tap CT of the inductor. The connection between the bond pad 603 and the centertap of the inductor is bifurcated by way of conductive lines 651 and 652.

Inductors 631 and 632 comprise windings 631a and 632a, respectively, that are interleaved as identified in FIGS. 6 and 7. Dielectric material separates the inductors to prevent shorting between the inductors. The inductors define interior spaces 681 and 682 as shown. Bond pad 601 couples to terminal 661 of inductor L2 by way of a conductive line 665, formed in a different conductive layer. Similarly, bond pad 602 couples to terminal 662 of inductor L2 by way of a conductive line 666. The conductive lines 651, 652, 665, and 666 are in one conductive layer which is a different conductive layer than the conductive layer in which the inductors 631 and 632 are formed. The conductive lines 651 and 652 to the centertap pass through the projectiosn of the interior spaces of the indcutors 631 and 632 as described above.

Current injected into, for example, bond pad 601 enters terminal 661 and flows counterclockwise as indicated by arrows 671 (FIG. 7) for multiple turns and then reverses direction (clockwise) as the current enters the bottom side of the inductor. From the centertap terminal 664, the current flows through conductive line 652 to bond pad 603, and then through conductive line 651 to centertap terminal 663. Reference numeral 681 indicates the direction of current flow through inductor 632 (counterclockwise in the top hald of the inductor and clockwise in the bottom half). The bifurcaton of the conductive lines 651 and 652 between the bond pad 603 and the centertap terminals 663 and 664 through the projections of the inductors' interior spaces provides a similar technical benefit as described above.

FIG. 9 is a block diagram of a system 700 in which the transformer 130 described herein can be used. System 700 includes a controller 702, and isolator 704, drivers 706 and 708, and a high side (HS) FET and a low side (LS) FET. In this example, both FETs are NFETs but either or both FETs can be implemented as other types of transistors. Driver 706 is connected to the gate of the HS FET, and driver 708 is connected to the gate of the LS FET. The source of the HS FET is coupled to the drain of the LS FET at a switch node (SW). The ground connection for driver 706 is coupled the switch node. Accordingly, driver 706 uses the switch node voltage as its ground reference 709.

The source of the LS transistor is coupled to circuit ground 711, which is the same ground reference used by the controller 702. The controller 702 produces output signals OUT1 and OUT2 to turn ON and OFF the corresponding HS and LS FETs. The voltage levels of OUT1 and OUT2 are referenced with respect to circuit ground 711. Isolator 704 has separate ground terminals connected to grounds 709 and 711 as shown. The isolator 704 includes the center-tapped transformer 130 described herein to provide isolation between grounds 709 and 711.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

As used herein, the terms “terminal”, “node”, and “interconnection” are used interchangeably. Unless specifically stated to the contrary, these terms are generally used to mean an interconnection between or a terminus of a device element, a circuit element, an integrated circuit, a device or other electronics or semiconductor component. Likewise, the terms “lead”, “pin” and “ball” are used interchangeably to mean an external interconnection of a semiconductor device.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors are described herein, other transistors (or equivalent devices) may be used instead with little or no change to the remaining circuitry. For example, a metal-oxide-silicon FET (“MOSFET”) (such as an n-channel MOSFET, nMOSFET, or a p-channel MOSFET, pMOSFET), a bipolar junction transistor (BJT—e.g. NPN or PNP), insulated gate bipolar transistors (IGBTs), and/or junction field effect transistor (JFET) may be used in place of or in conjunction with the devices disclosed herein. The transistors may be depletion mode devices, drain-extended devices, enhancement mode devices, natural transistors or other type of device structure transistors. Furthermore, the devices may be implemented in/over a silicon substrate (Si), a silicon carbide substrate (SiC), a gallium nitride substrate (GaN) or a gallium arsenide substrate (GaAs).

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +1-10 percent of that parameter, or, if the parameter is zero, a reasonable range of values around zero.

Modifications are possible in the described embodiments, and other embodiments are possible, within the scope of the claims.

What is claimed is:

1. A transformer, comprising:
a substrate;
a first metal layer comprising a first inductor having a first center tap;
a second metal layer comprising a second inductor having a second center tap, and the second metal layer including a bond pad;
a third metal layer including a first conductor electrically connecting the bond pad to the first center tap, and the third metal layer including a second conductor electrically connecting the bond pad and the first center tap; and
wherein the third metal layer is situated between the substrate and the first metal layer, and the first metal layer is situated between the third metal layer and the second metal layer.

2. The transformer of claim 1, wherein at least a portion of the first conductor is approximately parallel to at least a portion of the second conductor.

3. The transformer of claim 1, wherein:
the first inductor includes a first concentric ring and a second concentric ring, the first concentric ring defining a first interior space and the second concentric ring defining a second interior space;
the first center tap between the first concentric ring and the second concentric ring;
at least a portion of the first conductor extends through a projection of the first interior space; and
at least a portion of the second conductor extends through a projection of the second interior space.

4. The transformer of claim 3, wherein the first center tap is coupled to the first and second concentric rings such that a current flowing clockwise in the first concentric flows counterclockwise in the second concentric ring.

5. The transformer of claim 1, further comprising a first bond wire coupled to the second center tap and including a second bond wire coupled to the bond pad.

6. The transformer of claim 1, wherein the bond pad is a first bond pad, the transformer further comprises:
the second inductor includes a first concentric ring and a second concentric ring, the first concentric ring definng a first interior space and the second concentric ring defining a second interior space;
the second center tap coupled between the first concentric ring and the second concentric ring;
a second bond pad in the first interior space;
a third bond pad in the second interior space;
a first bond wire coupled to the second bond pad;
a second bond wire coupled to the third bond pad; and
a third bond wire coupled to the second center tap.

7. The transformer of claim 6, wherein the first inductor includes a third concentric ring and a fourth concentric ring, the first center tap coupled between the third and fourth concentric rings, and the first metal layer includes fourth and fifth bond pads, and the transformer includes:
a third conductive line coupled between the fourth bond pad and the third concentric ring; and
a fourth conductive line coupled between the fifth bond pad and the fourth concentric ring.

8. The transformer of claim 6, wherein at least one of the first or second conductive lines passes between at least one of the third or fourth bond pads and the substrate.

9. A transformer, comprising:
a substrate;
a first metal layer comprising a first inductor having first and second concentric conductors and having a first center tap coupled between the first and second concentric conductors, the first concentric conductor defining a first interior space, and the second concentric conductor defining a second interior space;
a second metal layer comprising a second inductor having a second center tap, the second metal layer including a bond pad; and
a third metal layer betw including a first conductor electrically connecting the bond pad to the first center tap through a projection of the first interior space, and including a second conductor electrically connecting the bond pad and the first center tap through a projection of the second interior space.

10. The transformer of claim 9, wherein at least a portion of the first conductor is approximately parallel to at least a portion of the second conductor.

11. The transformer of claim 9, wherein the first center tap is coupled to the first and second concentric rings such that a current flowing clockwise in the first concentric flows counterclockwise in the second concentric ring.

12. The transformer of claim 9, further comprising a first bond wire coupled to the second center tap and including a second bond wire coupled to the bond pad.

13. The transformer of claim 9, wherein:
the second inductor includes a third concentric ring and a fourth concentric ring, the third concentric ring defining a third interior space and the fourth concentric ring defining a fourth interior space; and
the second center tap coupled between the third concentric ring and the fourth concentric ring.

14. The transformer of claim 13, wherein the bond pad is a first bond pad, and the transformer further comprises:
a second bond pad in the third interior space;
a third bond pad in the fourth interior space;
a first bond wire coupled to the second bond pad;
a second bond wire coupled to the third bond pad; and
a third bond wire coupled to the second center tap.

15. The transformer of claim 14, wherein:
the first metal layer includes a fourth bond pad and a fifth bond;
a third conductro coupling the fourth bond pad to the first concentric ring;
a fourth conductor coupling the fifth bond pad to the second concentric ring; and
at least one of the first or second conductors passes between at least one of the fourth or fifth bond pads and the substrate.

16. A transformer, comprising:
a substrate;
a first metal layer comprising a bond pad and a first center-tapped inductor, the first centertapped inductor comprising first and second interleaved windings, a first end of the first interleaved winding coupled to the bond pad by a first conductive line, and a second end of the second interleaved winding coupled to the bond pad by a second conductive line; and
a second metal layer layer comprising a second inductor, the first metal layer formed between the second metal layer and the substrate.

17. The transformer of claim 16, wherein the first and second conductive lines are in a third metal layer between the first metal and the substrate.

18. The transformer of claim 16, wherein the second inductor is a center-tapped inductor.

19. The transformer of claim 16, wherein the first interleaved winding comprises a first concentric ring and a second current concentric ring, and the second interleaved winding comprises a third concentric ring and a fourth current concentric ring

20. The transformer of claim 19, wherein the first and second concentric rings are arranged such that current flowing in the first concentric ring flows clockwise while current flowing in the second concentric ring flows counterclockwise.
